(19) United States
(12) Patent Application Publication
(10) Pub. No.: US 2025/0156698 A1
(43) Pub. Date: May 15, 2025

(54) EXPLAINABLE MACHINE LEARNING SUBTASK ARCHITECTURE

(71) Applicant: FAIR ISAAC CORPORATION, Minneapolis, MN (US)

(72) Inventors: Scott Michael Zoldi, San Diego, CA (US); Yuchen Chen, San Diego, CA (US)

(21) Appl. No.: 18/506,816

(22) Filed: Nov. 10, 2023

(51) Int. Cl. G06N 3/0499

(52) U.S. Cl. CPC G06N 3/0499

(57) ABSTRACT

A computer-implemented method for generating a classifier, comprising: assigning a plurality of hierarchies of tags to a collection of training examples, wherein a higher level tag of the plurality of hierarchies of tags comprises a set of lower level tags; associating, in the classifier, a plurality of latent features with each of the plurality of hierarchies of tags, respectively; constructing a plurality of loss functions, wherein each loss function is associated with each level of the plurality of hierarchies of tags and associated latent features of the classifier, wherein the loss function aggregates a plurality of binary cross entropy for each member of a level of tags and associated latent features; and training the classifier by minimizing the loss functions for each level of the plurality of hierarchies of tags and associated latent features of the classifier.

### TECHNICAL FIELD

The subject matter described herein relates to systems and methods for using Machine Learning (ML) technique to make predictions, for example generating explainable subtask classifiers.

### BACKGROUND

In recent years, Machine Learning (ML) models have gained widespread adoption across various industries for predictive purposes. For instance, in the retail sector, predictive models are utilized to forecast customer demand, optimize inventory levels, and personalize marketing campaigns, ultimately resulting in increased sales and improved customer satisfaction. In healthcare, predictive models play a crucial role in patient diagnosis, treatment recommendations, and disease outbreak predictions, contributing to enhanced patient care and proactive healthcare management. Furthermore, within the financial industry, ML models are employed for credit risk assessment, fraud detection, and market trend predictions, thereby enhancing decision-making processes and mitigating potential risks. These examples illustrate the substantial impact of predictive ML models, transforming industries and driving data-driven decision-making across diverse sectors.

There are cases where providing explanations for classifier outputs becomes essential or, in some instances, required, due to, for example, regulatory requirements. Moreover, these explanations can offer valuable insights for further model development in various scenarios. Some models are inherently explainable, for example, linear regression, logistic regression, and single decision trees. These models may generally possess transparent structures that allow users to see the direct relationship between input features and outputs. Linear and logistic regression models, for instance, provide coefficients for each feature, indicating the weight or importance of that feature in prediction. Decision trees, on the other hand, offer a hierarchical structure of decisions based on feature values, making the path to any prediction traceable and understandable. Such models often become the first choice in scenarios where interpretability is paramount, despite potentially sacrificing some predictive accuracy compared to more complex counterparts. However, interpreting the results of complex machine learning models, including deep neural networks, random forests, and support vector machines, can be intricate and challenging. This complexity may arise from the ‘discovery’ nature of some complex classifiers, meaning that the classifier does not know what to look for prior to training and learns relationships through training on data samples. Additionally, the inherent architecture of certain models, particularly deep neural networks with multiple layers, can obfuscate their decision-making processes. The interplay and weighting of features can become non-intuitive in these multi-layer structures, making it difficult to pinpoint the exact contributions of individual features to the final decision. Moreover, the features are inputs to more complex nonlinear relationships that are responsible and may represent the physical or causal relationship/reason that should be explained. Random forests, which rely on aggregating decisions from a multitude of decision trees, introduce another layer of complexity. Tracing back a specific prediction through all the trees to understand the collective reasoning can be difficult, and ultimately an averaging of votes across many trees may be generated. Support vector machines, on the other hand, operate in high-dimensional spaces and use complex transformations, often making their decision boundaries challenging to visualize and understand in the original feature space.

While models that are explainable typically have a simple structure, there is a growing demand to leverage more complex models, such as neural networks, while still maintaining the ability to provide clear explanations that link to actual observed occurrences in the data. In some instances, reasons to be reported are prescribed and models may be informed that their decision space may support these physical or causal relationships in training. Therefore, there is a need for platforms, systems, and methods that can generate machine learning models or classifiers that are specifically designed to provide comprehensive prescribed physical or causal explanations for their outputs versus approximations or data driven correlative nonlinear relationships.

### SUMMARY

Methods, systems, and articles of manufacture, including computer program products, are provided for generating ML classifier for data owners. In one aspect, there is provided a system. The system may include at least one processor and at least one memory. The at least one memory may store instructions that result in operations when executed by the at least one processor. The operations may include: assigning a plurality of hierarchies of tags to a collection of training examples, wherein a higher level tag of the plurality of hierarchies of tags comprises a set of lower level tags; associating, in the classifier, a plurality of latent features with each of the plurality of hierarchies of tags, respectively; constructing a plurality of loss functions, wherein each loss function is associated with each level of the plurality of hierarchies of tags and associated latent features of the classifier, wherein the loss function aggregates a plurality of binary cross entropy for each member of a level of tags and associated latent features; and training the classifier by minimizing the loss functions for each level of the plurality of hierarchies of tags and associated latent features of the classifier.

In some variations, each of the set of lower level tags contributes exclusively to one higher level tag.

In some variations, the operations further comprise generating an output using the trained classifier, wherein the output comprises a ranked set of explanations attributed to one or more of a set of the associated latent features.

In some variations, the latent features comprises underlying patterns or factors that the classifier learns from the training examples that contribute to one or more of the plurality of hierarchies of tags.

In some variations, by minimizing the loss functions, a set of optimal values of learning parameters is determined, wherein the learning parameters comprise weights and bias terms that define how each latent feature contributes to one or more of the tags.

In some variations, the output further comprises a probability percentage indicative of each of the explanations contribute to a predicted result based on the learning parameters.

In some variations, the classifier comprises a feedforward neural network.

In another aspect, there is provided a method. The method includes: assigning a plurality of hierarchies of tags to a collection of training examples, wherein a higher level tag of the plurality of hierarchies of tags comprises a set of lower level tags; associating, in the classifier, a plurality of latent features with each of the plurality of hierarchies of tags, respectively; constructing a plurality of loss functions, wherein each loss function is associated with each level of the plurality of hierarchies of tags and associated latent features of the classifier, wherein the loss function aggregates a plurality of binary cross entropy for each member of a level of tags and associated latent features; and training the classifier by minimizing the loss functions for each level of the plurality of hierarchies of tags and associated latent features of the classifier.

In another aspect, there is provided a computer program product including a non-transitory computer readable medium storing instructions. The operations include assigning a plurality of hierarchies of tags to a collection of training examples, wherein a higher level tag of the plurality of hierarchies of tags comprises a set of lower level tags; associating, in the classifier, a plurality of latent features with each of the plurality of hierarchies of tags, respectively; constructing a plurality of loss functions, wherein each loss function is associated with each level of the plurality of hierarchies of tags and associated latent features of the classifier, wherein the loss function aggregates a plurality of binary cross entropy for each member of a level of tags and associated latent features; and training the classifier by minimizing the loss functions for each level of the plurality of hierarchies of tags and associated latent features of the classifier.

Implementations of the current subject matter can include, but are not limited to, methods consistent with the descriptions provided herein as well as articles that include a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to generating explanations for explainable machine learning subtask architectures, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating an example of a hierarchy of tags for the training examples, in accordance with one or more embodiments of the current subject matter.

FIG. 2 is a diagram illustrating an example of generating an explainable machine learning subtask architecture, in accordance with one or more embodiments of the current subject matter.

FIG. 3 is a process flow diagram illustrating a process for the platform and systems provided herein to develop an explainable machine learning subtask architecture, according to one or more implementations of the current subject matter.

FIG. 4 depicts a block diagram illustrating an example of a computing system, consistent with implementations of the current subject matter.

FIG. 5 illustrates a diagram depicting the implementation of a proposed system for this use case, consistent with implementations of the current subject matter.

FIG. 6 is a diagram illustrating the results comparing baseline classifier and an explainable machine learning subtask architecture using the embodiments described herein.

When practical, like labels are used to refer to same or similar items in the drawings.

### DETAILED DESCRIPTION

The details of one or more variations of the subject matter described herein are set forth in the accompanying drawings.

As discussed herein elsewhere, there is a need for platforms, systems, and methods that can generate machine learning models or classifiers that are specifically designed to provide prescribed physical or causal reasons/explanations for their outputs.

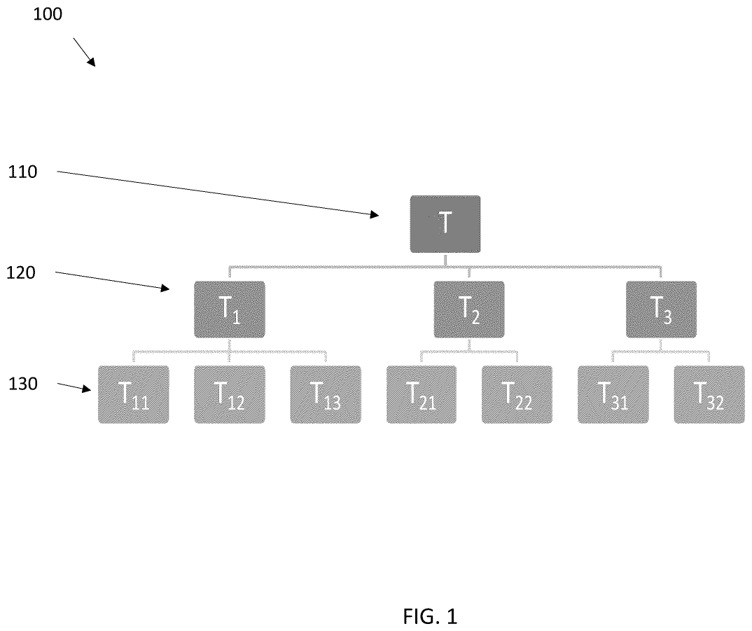

FIG. 1 is a diagram illustrating an example of a hierarchy of tags for the training examples, in accordance with one or more embodiments of the current subject matter. As shown in FIG. 1, three levels 110, 120, and 130 of hierarch of tags may be assigned to training examples. In some embodiments, level 110 may include one tag T, which may be a superset of a class that is made up of T₁, T₂ and T₃ subclass, denoted by level 120. As shown in FIG. 1, T₁, as a subclass, may in turn be made up of sub-subclasses T₁₁, T₁₂, T₁₃. T₂ may be made up of sub-subclasses T₂₁, and T₂₂. T₃ may be made up of sub-subclasses T₃₁, and T₃₂. Those sub-subclasses may compose the level 130 of the tags. Each sub-subclass is a part of the superset of the parent subclass and represent a physical or causal occurrence in the data. In some embodiments, a higher level tag of the plurality of hierarchies of tags includes a set of lower level tags. For example, level 110 tag T includes level 120 tags T₁, T₂ and T₃; and a level 120 tag T₁ includes level 130 tags T₁₁, T₁₂, and T₁₃. In some embodiments, each of the set of the lower level tags contributes exclusively to one higher level tag. For example, tag T₁₂ contributes exclusively to Tag T₁, and do not contribute to any other tags. This may ensure a clear and unambiguous categorization of data. By maintaining such exclusivity, the system effectively eliminates potential overlaps, ensuring a more streamlined and coherent training process for machine learning models. Additionally or alternatively, aligning the training of latent features representing the learned nonlinearities with the observed subtasks may ensure that the classifier account the reason for a prediction. This exclusivity may also reduce any potential overlapping influences, task potential interference or negative transfer in the training process, facilitating categorized and precise training regimen for machine learning algorithms.

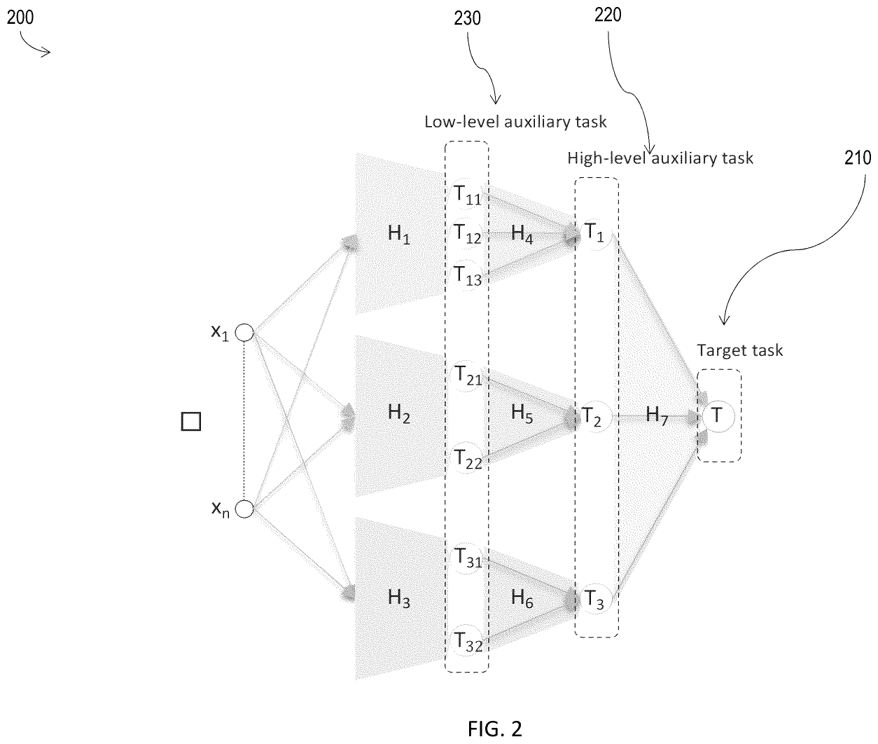

FIG. 2 is a diagram illustrating an example of generating an explainable machine learning subtask architecture, in accordance with one or more embodiments of the current subject matter. As shown in FIG. 2, the classifier training process may be segmented into one or more tasks 210, 220, and 230, for example, based on the number of levels of subclasses of behaviors in the training data set. In some embodiments, the classifier training process may be associated with target class T, subclasses T_i and sub-subclasses T_ii with them trained together through gradient descent. The hierarchy may encompass multiple tiers, not restricted to just two levels of subclasses. Through auxiliary tasks, the classifier may optimize the prediction of the granular tags (e.g., T₁, T₁₁, T₁₂, T₁₃, T₂, T₂₁, T₂₂, T₃, T₃₁, and T₃₂), using distinct sets of learning parameters like H1, H2, H3, H4, H5, and H6, as shown in FIG. 2. This process may narrow down the latent space, which may ensure that each latent feature directly corresponds to a single, coherent explanation corresponding to the physical or causal subtask, which could be depicted as a subclass or sub-subclass in this context. In some embodiments, the latent features may include underlying patterns or factors that the classifier learns from the training examples that contribute to one or more of the tags. Consequently, the categorized latent space derived from these auxiliary tasks may define a set of the latent features, which are then used to predict the primary task (T), optimizing a collective of tags through another set of learning parameters, denoted as H7. In some embodiments, the learning parameters may include weights and bias terms that define how each latent feature contributes to one or more of the tags. In some embodiments, the learning parameters may bridge two layers of the tags, for example, treating a lower level tag as a latent feature that contributes to a higher level tag. In some embodiments, the learning parameters may be adjusted during the training process so to generate a set of optimal values for the learning parameters that minimize a loss function.

As shown in FIG. 2, the auxiliary tasks could be multi-layered (e.g., as illustrated by elements 210, 220 and 230), just as the tags can be segmented to give different levels of detail: T₁₁, T₁₂, T₁₃, T₂₁, T₂₂, T₃₁, T₃₂ versus T₁, T₂, and T₃. In the multi-layered auxiliary tasks, the latent space from the high-level auxiliary task 220 is exclusively contributed by the corresponding low-level auxiliary tasks 230 that optimize tags that belong to the same subclass. T₁₁, T₁₂, and T₁₃ are exclusively connected to T₁ instead of T₂ or T₃. T₂1 and T₂₂ are exclusively connected to T₂ instead of T₁ or T₃. T₃₁ and T₃₂ are exclusively connected to T₃ instead of T₁ or T₂. Subclasses T₁, T₂, and T₃ are connected to T.

In some embodiments, the subclass and sub-subclass auxiliary explainability task training approach may utilize a feed forward neural network architecture for model training through gradient descent. The gradient descent is an iterative optimization algorithm used to find the values of learning parameters that minimize the loss function. The subclass and sub-subclass auxiliary explainability task training implements a number of objective functions, for example, one for the low-level auxiliary task 230, one for high-level auxiliary task 220, and one for target task 210, as presented in Equation 1:

$$optimize {obj\_func}_{low - level auxiliary task} + {obj\_func}_{high - level auxiliary task} + {obj\_func}_{t a rget task} \qquad Equation 1$$

The objective function of low-level auxiliary task 230 may optimize for all sub-subclass tags, high-level auxiliary task 220 for all subclass tags, and target task 210 for the superset of tags. A common objective function of a feed forward neural network for the classification problem is to minimize the binary cross entropy (BCE):

$$B C E ( y , {y}^{′} ) = - ( y log {y}^{′} + ( 1 - y ) log ( 1 - {y}^{′} ) ) ,$$

where y is the true tag and y′ is the probability of finding the corresponding true tag.

In some embodiments, the Equation 2 may present the objective function of the low-level auxiliary task 230 shown in FIG. 2:

$${\sum }_{i = 1 … 3} BCE ( {T}_{1 i} , {T}_{1 i}^{′} ) + {\sum }_{j = 1 … 2} BCE ( {T}_{2 j} , {T}_{2 j}^{′} ) + {\sum }_{k = 1 … 2} BCE ( {T}_{3 k} , {T}_{3 k}^{′} ) \qquad Equation 2$$

In some embodiments, the Equation 3 may present the objective function of the high-level auxiliary task 220 shown in FIG. 2:

$${\sum }_{l = 1 … 3} BCE ( {T}_{l} , {T}_{l}^{′} ) \qquad Equation 3$$

In some embodiments, the Equation 4 may present the objective function of the target task shown in FIG. 2:

$$BCE ( T , {T}^{;} ) \qquad Equation 4$$

Once trained, the explanation may be based on a cascaded contribution to the output score back to the latent features that drive the outcomes, where comparison of the impact to final score is attributed to the sub-subtask latent features to allowing a ranked set of explanations to be produced by the architecture. In some embodiments, the ranked set of explanations may correspond to the physical or causal relevant subclass tasks on which the model is supposed to represent its explanation space.

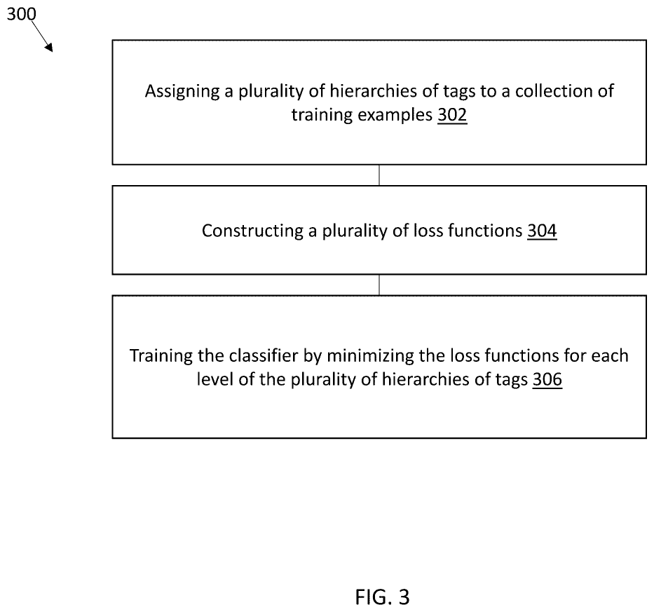

FIG. 3 is a process flow diagram illustrating a process 300 for the platform and systems provided herein to develop an explainable machine learning subtask architecture. In some implementations, the process may start with operation 302, wherein the system may assign a plurality of hierarchies of tags to a collection of training examples. In some embodiments, a higher level tag may include a set of lower level tags, for example, as shown in FIG. 1, level 110 tag T includes level 120 tags T₁, T₂ and T₃; and a level 120 tag T₁ includes level 130 tags T₁₁, T₁₂, and T₁₃. In some embodiments, each of the lower level tags contributes exclusively to one higher level tag. In some embodiments, a lower level tags may include specific medical conditions, symptoms, or diagnostic indicators that are subsets of the encompassing higher-level tag. For instance, within the healthcare domain, if the higher-level tag is “Respiratory Disorders”, lower-level tags could be specific conditions like “Asthma”, “Bronchitis”, and “Pneumonia”. Further, the tag “Asthma” might further have even more granular tags representing different asthma types or specific symptoms associated with asthma. For example, “Allergic Asthma”, “Exercise-Induced Asthma”, or symptoms like “Shortness of Breath” and “Wheezing”. Each of these granular tags provides a finer level of detail and specificity. In some embodiments, operation 302 may further include associating, in the classifier, latent features with each of the plurality of hierarchies of tags. For example, a latent feature of “observed high blood pressure for three consecutive days” may be associated with a tag of “high blood pressure”. In some embodiments, this latent feature may be linked to a machine learning classifier, for example, the classifier trained on the current set of training examples.

With this hierarchically tagged training dataset, the process 300 may proceed to operation 304, wherein the system may construct a plurality of loss functions, with each loss function associated with each level of the plurality of hierarchies of tags. In some embodiments, the loss function may aggregate a plurality of binary cross entropy for each member of a level of tags. For example, in the healthcare context, when generating a classifier that predicts the likelihood of specific diseases or conditions, the loss functions may include a disease-level loss function for the most high-level tag; a sub-disease-level loss function for a mid-level tag, and a condition-level loss function for a low-level tag. In some embodiments, the disease-level loss function may optimize the model's over all prediction for broad categories of diseases, for example, a cardiovascular disease. A sub-disease-level loss function may focus on specific types of cardiovascular diseases, such as “hypertension” or “Coronary Artery Disease.” A condition-level loss function may consider very specific conditions or variations of a disease, for example, specific test results, medication interactions, or genetic markers to optimize its predictions.

The process 300 may then proceed to operation 306, wherein the system may train the classifier by minimizing the loss functions for each level of the plurality of hierarchies of tags. Therefore, the system may optimize predictions for each level independently, thereby reduce the latent space and prescribing it to physical or causal meanings. In some embodiments, by focusing on each level of the hierarchically tagged training data, the resultant classifier may be able to discern the contributor to the outcomes, thereby enhancing expandability of the classifier. In some embodiments, a set of optimal values for the learning parameters is determined by minimizing the loss functions, wherein the learning parameters include weights and bias terms that define how each latent feature contributes to one or more of the tags. For example, the latent feature may include patterns or attributes extracted from the input data, such as genetic markers, protein levels, and medical imaging results in the context of healthcare. These latent features essentially capture the underlying structures or trends in the dataset that might not be directly observable. The learning parameters may include specific weightings given to each of these latent features and the bias terms that provide a baseline prediction in the absence of input data. These weightings and bias terms may determine how the classifier interprets and acts upon the latent features. By refining and adjusting these learning parameters, the system may ensure that the most relevant and significant latent features corresponding to physically observed occurrences are given prominence when making predictions. This approach, combined with the hierarchical tagging, offers a more holistic and granular view of the data, allowing for more precise and actionable physically observed insights.

In some embodiments, the output of the trained classifier may include a ranked set of explanations attributed to one or more of a set of latent features. For example, the classifier may rank the following reasons in the following order as the explanation for a positive cancer diagnosing: 1) MRI-detected tumor patterns, 2) high-risk BRCA1 gene mutation, and 3) elevated white blood cell count. These prioritized explanations provide user with a concise understanding of the classifier's diagnostic rationale to aid in human decisioning based on use of the model.

In some embodiments, the output further includes a probability percentage indicative of each of the explanations contribute to a predicted result based on the learning parameters. For example, in predicting the likelihood of a patient having a heart disease, the classifier might provide: 1) Family history of heart disease—35%, 2) Elevated cholesterol levels—25%, and 3) Sedentary lifestyle—20%. These percentages offer user a quantitative perspective on the prediction's underlying reasons.

### Use Case 1

The systems and methods provided herein may be used in various industries wherein physical or causal relevant explainability of classifiers is desirable. For example, the proposed approach may be utilized to generate personalized disease risk prediction for patients in a hospital. The hospital may leverage the ML classifier to predict the likelihood of patients developing specific diseases based on their medical history, lifestyle, genetic markers, and medical imaging results, etc. The goal is to generate explainable classifiers that give patients and doctors insights into actionable and observed potential health risks, making preventive measures more effective.

The hospital may first collect diverse patient data, including medical history, genetic data, medical imaging, and more. Using the process described in FIGS. 1-3, this data may be hierarchically tagged. At the highest level, broad categories like “Respiratory Disorders” or “Cardiovascular Diseases” may be used. These categories may be further broken down to specific conditions such as “Asthma” or “Hypertension.” Finally, at a more granular level, specific symptoms or genetic markers, like “Exercise-Induced Asthma” or “BRCA1 gene mutation,” are tagged. With this hierarchically tagged dataset, a classifier may be trained. This may include constructing multiple loss functions, one for each hierarchical level, ensuring the model is optimized for each level of granularity of prediction. For instance, the model will have a broad understanding of cardiovascular diseases, a more detailed comprehension of specific conditions like hypertension, and an intricate knowledge of specific indicators like certain test results or genetic markers. The training process may utilize gradient descent to iterate the optimization process by minimizing the loss functions for each level, which may produce optimal values for a set of learning parameters for the classifier. The learning parameters may include weights and bias terms that define how each latent feature contributes to one or more of the tags, and the latent features may include underlying patterns or factors that the classifier learns from the training examples that contribute to one or more of the tags. For example, latent features for determining a cardiovascular diseases that are determined by the ML classifier during training may include high blood pressure for a week, irregularities in heart rate patterns over a month, elevated cholesterol levels from recent blood tests, specific genetic markers associated with heart diseases, and patterns of arterial blockage in medical imaging. Each of these latent features would be assigned specific weights by the learning parameters, based on their relevance and significance to the diagnosis.

Once trained, the classifier may predict a patient's likelihood of developing specific conditions. It may also provide a ranked set of explanations based on one or more latent features that the ML classifier ascertained during training. For example, when evaluating a patient's cancer risk, the model might rank MRI-detected tumor patterns as the most influential factor, followed by specific genetic markers and then particular blood test results. This ranking offers doctors a clear view of why the model has made its prediction, aiding in informed and physical or causal relevant decision-making. In some instances, other than the ranked explanations, the classifier may also output the probability percentage of each contributing factor. For example, if a patient were being assessed for heart disease risk, the classifier might indicate that, in this prediction, family history contributes 35% to predicted risk, elevated cholesterol levels contribute 25%, and a sedentary lifestyle adds another 20%. This quantitative perspective provides both patients and doctors with a clearer explanation of the classifier's prediction.

### Use Case 2

The systems and methods provided herein may be used in various industries wherein explainability of classifiers is desirable. In a second use case, the present subject matter, as illustrated through an anti-money laundering case study, was devised to evaluate the efficacy of auxiliary subclass and sub-subclass auxiliary explanation task training in the precise allocation of reasons and enhanced detection performance, particularly in comparison to existing baseline models employed for the detection of money laundering. Historical transactional data, inclusive of Suspicious Activity Reports (SAR) tags, three subclass tags (namely, cash, dormant, and rapid in/out), and ten sub-subclass tags (with five pertaining to cash, three to dormant, and two to rapid in/out), were acquired from a reputable financial institution.

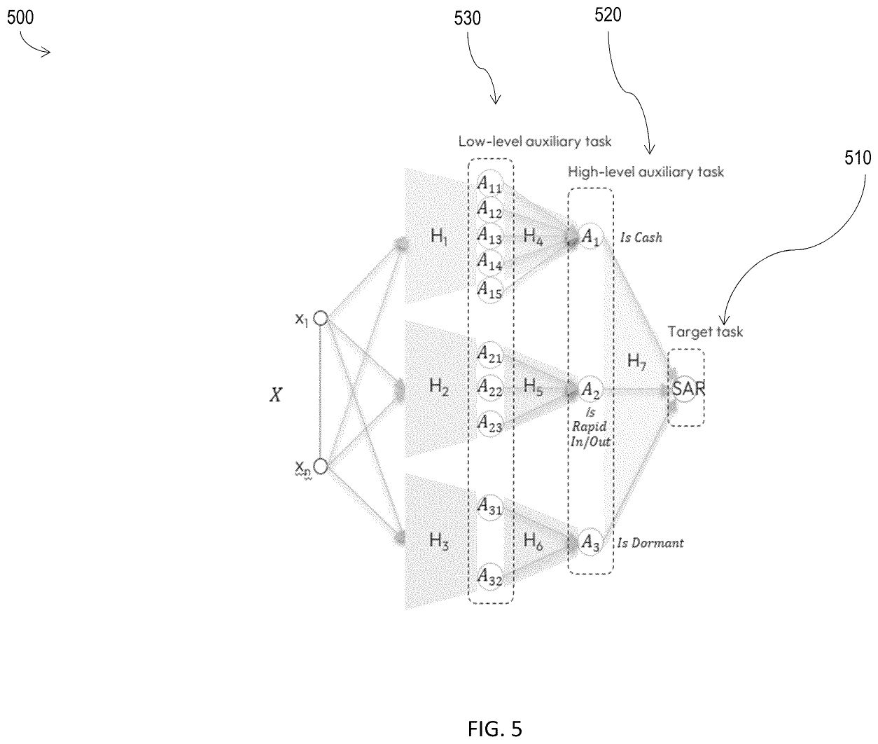

FIG. 5 illustrates a diagram depicting the implementation of a proposed system for this use case. In this schematic representation, ten lower-tier auxiliary tasks 530 (shown as A₁ through A₃₂) are utilized to direct the formation of a latent space aligned with the pertinent reasoning. Moreover, three upper-tier auxiliary tasks 520, namely Cash, Rapid in/out, and Dormant activity (designated as A₁, A₂, and A₃) may shape the latent space to align with the associated tag cluster. This model may indicate that the latent features derived from lower-tier tasks contribute exclusively to their respective upper-tier tasks, which may subsequently influence the primary target task 510.

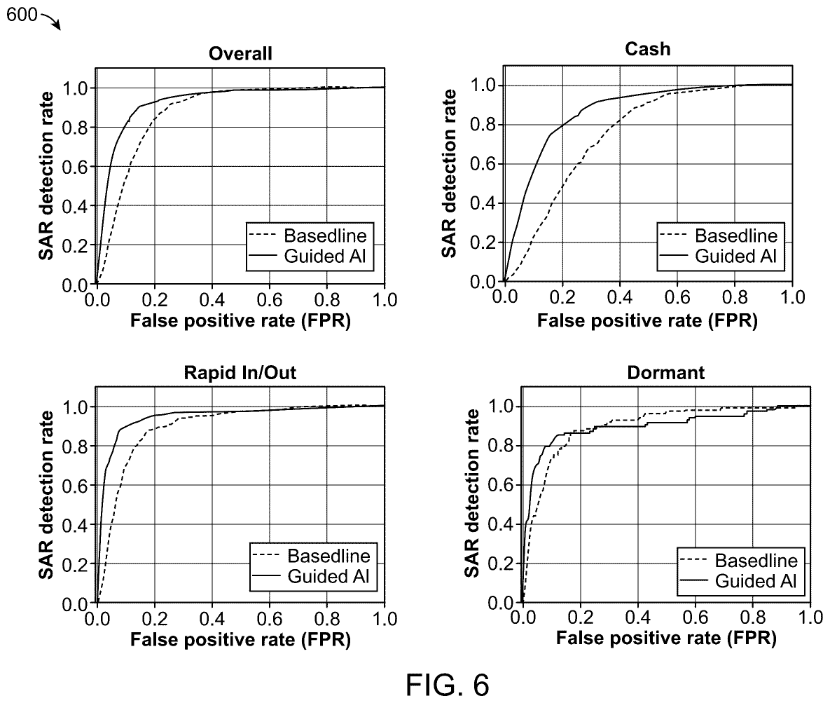

FIG. 6 is a diagram illustrating the results comparing baseline classifier and classifier trained using the embodiments described herein. Emphasized in the results shown in below table 1, and further highlighted in FIG. 6, is the superiority of the auxiliary subclass and sub-subclass approach, especially in SAR detection at a 1% false positive rate (FPR), when compared with conventional baseline models. The proposed method showcases substantial relative advancements, which include a staggering 613% enhancement in overall SAR detection at a 1% FPR threshold. Specific segments, such as cash, rapid in/out, and dormant, registered improvements of 757%, 1075%, and 714%, respectively. Notably, traditional models, which lean heavily on top-level tags derived primarily from rule-based systems, comes short when comparing with the sophistication and precision of the subclass and sub-subclass methodology. Given the rigorous mandates set forth by regulatory authorities in the realm of Anti-Money Laundering (AML), the proposed system not only paves the way for innately designed explainability but also fine-tunes detection mechanisms, thus overshadowing rudimentary rule-based systems prevalent.

TABLE 1

| | SAR detection rate at 1% FPR | | |
|---|---|---|---|
| | | Auxiliary Explanation | |
| | Baseline | Task Training | Relative Improvement |
| Overall | 1.4% | 9.7% | 613.4% |
| Cash | 0.5% | 4.1% | 757.1% |
| Rapid In/Out | 1.5% | 17.9% | 1075.8% |
| Dormant | 2.7% | 22.0% | 714.9% |
| | SAR detection rate at 2% FPR | | |
| | | Auxiliary Explanation | |
| | Baseline | Task Training | Relative Improvement |
| Overall | 2.95% | 16.49% | 458.9% |
| Cash | 1.12% | 8.53% | 661.9% |
| Rapid In/Out | 4.40% | 30.59% | 595.3% |
| Dormant | 9.28% | 31.09% | 235.1% |
| | SAR detection rate at 5% FPR | | |
| | | Auxiliary Explanation | |
| | Baseline | Task Training | Relative Improvement |
| Overall | 10.93% | 35.06% | 220.8% |
| Cash | 3.11% | 18.30% | 488.5% |
| Rapid In/Out | 16.76% | 52.58% | 213.7% |
| Dormant | 27.28% | 48.24% | 76.8% |

The proposed approach has a primary focus on tailoring model designs to align with the subclass and sub-subclass auxiliary explanation tasks. Consequently, a comparative analysis was conducted between reason assignments produced by the model and data procured directly from the financial institution. As shown in below table 2, the proposed approach boasted an average hit rate of 95.8% in the correct explanation, signifying its precision in allocating the correct rationale to SARs. This inventive methodology significantly outperformed the “Reason Reporter”—a recognized industry benchmark for model-agnostic reason reporting in fraudulent activities, which registered a weighted average hit rate of a mere 38.3% in the allocation of reasons to the ten sub-subclasses. Central to its design, the proposed model is adept at learning multiple auxiliary tasks concurrently, utilizing a shared latent space, thereby elevating the generalization across multiple tasks.

TABLE 2

| | | | | Subclass and |
|---|---|---|---|---|
| | | | | Sub-subclass |
| | Sub- | Total | Reason | Auxiliary Explanation |
| Subclass | subclass | SARs | Reporter | Task Training |
| Cash | A11 | 296 | 89.5% | 96.96% |
| Cash | A12 | 375 | 14.7% | 96.00% |
| Cash | A13 | 18 | 27.8% | 83.33% |
| Cash | A19 | 1 | 0.0% | 0.00% |
| Cash | A1B | 4 | 25.0% | 100.00% |
| Rapid In/Out | A16 | 24 | 54.2% | 83.33% |
| Rapid In/Out | A17 | 161 | 14.3% | 99.38% |
| Rapid In/Out | A1A | 117 | 9.4% | 99.15% |
| Dormant | A14 | 32 | 37.5% | 96.88% |
| Dormant | A15 | 24 | 75.0% | 100.00% |
| | | Weighted | 38.3% | 96.7% |
| | | Average | | |

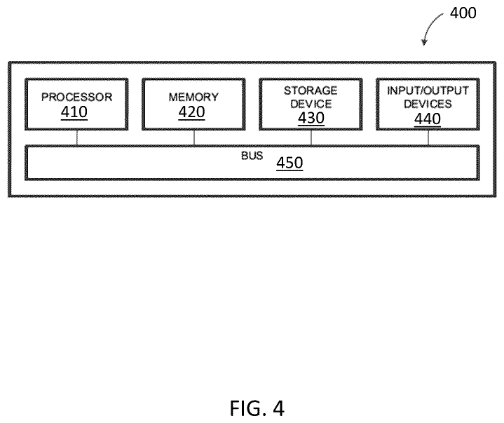

FIG. 4 depicts a block diagram illustrating a computing system 400 consistent with implementations of the current subject matter. Referring to FIGS. 1-4, the computing system 400 can be used to implement the platform 100, the classifier developer system 120, the intervention module 124, and/or any components therein.

As shown in FIG. 4, the computing system 400 can include a processor 410, a memory 420, a storage device 430, and input/output devices 440. The processor 410, the memory 420, the storage device 430, and the input/output devices 440 can be interconnected via a system bus 450. The computing system 400 may additionally or alternatively include a graphic processing unit (GPU), such as for image processing, and/or an associated memory for the GPU. The GPU and/or the associated memory for the GPU may be interconnected via the system bus 450 with the processor 410, the memory 420, the storage device 430, and the input/output devices 440. The memory associated with the GPU may store one or more images described herein, and the GPU may process one or more of the images described herein. The GPU may be coupled to and/or form a part of the processor 410. The processor 410 is capable of processing instructions for execution within the computing system 400. Such executed instructions can implement one or more components of, for example, the diffusion system 100, the machine learning engine 110, the first machine learning model 120, the second machine learning model 125, and/or the like. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided via the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 440. The user interface can be generated and presented to a user by the computing system 400 (e.g., on a computer screen monitor, etc.).

One or more aspects or features of the subject matter described herein can be realized in digital electronic circuitry, integrated circuitry, specially designed framework specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software frameworks, frameworks, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method for generating a classifier, comprising:
assigning a plurality of hierarchies of tags to a collection of training examples, wherein a higher level tag of the plurality of hierarchies of tags comprises a set of lower level tags;
associating, in the classifier, a plurality of latent features with each of the plurality of hierarchies of tags, respectively;
constructing a plurality of loss functions, wherein each loss function is associated with each level of the plurality of hierarchies of tags and associated latent features of the classifier, wherein the loss function aggregates a plurality of binary cross entropy for each member of a level of tags and associated latent features; and
training the classifier by minimizing the loss functions for each level of the plurality of hierarchies of tags and associated latent features of the classifier.

2. The method of claim 1, wherein each of the set of lower level tags contributes exclusively to one higher level tag.

3. The method of claim 1, further comprising:
generating an output using the trained classifier, wherein the output comprises a ranked set of explanations attributed to one or more of a set of the associated latent features.

4. The method of claim 3, wherein the latent features comprises underlying patterns or factors that the classifier learns from the training examples that contribute to one or more of the plurality of hierarchies of tags.

5. The method of claim 3, wherein by minimizing the loss functions, a set of optimal values of learning parameters is determined, wherein the learning parameters comprise weights and bias terms that define how each latent feature contributes to one or more of the tags.

6. The method of claim 5, wherein the output further comprises a probability percentage indicative of each of the explanations contribute to a predicted result based on the learning parameters.

7. The method of claim 1, wherein the classifier comprises a feedforward neural network.

8. A computer program product comprising a non-transient machine-readable medium storing instructions that, when executed by at least one programmable processor, cause the at least one programmable processor to perform operations comprising:
assigning a plurality of hierarchies of tags to a collection of training examples, wherein a higher level tag of the plurality of hierarchies of tags comprises a set of lower level tags;
associating, in a classifier, a plurality of latent features with each of the plurality of hierarchies of tags, respectively;
constructing a plurality of loss functions, wherein each loss function is associated with each level of the plurality of hierarchies of tags and associated latent features of the classifier, wherein the loss function aggregates a plurality of binary cross entropy for each member of a level of tags and associated latent features; and
training the classifier by minimizing the loss functions for each level of the plurality of hierarchies of tags and associated latent features of the classifier.

9. The computer program product of claim 8, wherein each of the set of lower level tags contributes exclusively to one higher level tag.

10. The computer program product of claim 8, wherein the operations further comprises generating an output using the trained classifier, wherein the output comprises a ranked set of explanations attributed to one or more of a set of the associated latent features.

11. The computer program product of claim 10, wherein the latent features comprises underlying patterns or factors that the classifier learns from the training examples that contribute to one or more of the plurality of hierarchies of tags.

12. The computer program product of claim 10, wherein by minimizing the loss functions, a set of optimal values of learning parameters is determined, wherein the learning parameters comprise weights and bias terms that define how each latent feature contributes to one or more of the tags.

13. The computer program product of claim 12, wherein the output further comprises a probability percentage indicative of each of the explanations contribute to a predicted result based on the learning parameters.

14. The computer program product of claim 8, wherein the classifier comprises a feedforward neural network.

15. A system comprising:
a programmable processor; and
a non-transient machine-readable medium storing instructions that, when executed by the processor, cause the at least one programmable processor to perform operations comprising:
assigning a plurality of hierarchies of tags to a collection of training examples, wherein a higher level tag of the plurality of hierarchies of tags comprises a set of lower level tags;
associating, in a classifier, a plurality of latent features with each of the plurality of hierarchies of tags, respectively;
constructing a plurality of loss functions, wherein each loss function is associated with each level of the plurality of hierarchies of tags and associated latent features of the classifier, wherein the loss function aggregates a plurality of binary cross entropy for each member of a level of tags and associated latent features; and
training the classifier by minimizing the loss functions for each level of the plurality of hierarchies of tags and associated latent features of the classifier.

16. The system of claim 15, wherein each of the set of lower level tags contributes exclusively to one higher level tag.

17. The system of claim 15, wherein the operations further comprises generating an output using the trained classifier, wherein the output comprises a ranked set of explanations attributed to one or more of a set of the associated latent features.

18. The system of claim 17, wherein the latent features comprises underlying patterns or factors that the classifier learns from the training examples that contribute to one or more of the plurality of hierarchies of tags.

19. The system of claim 17, wherein by minimizing the loss functions, a set of optimal values of learning parameters is determined, wherein the learning parameters comprise weights and bias terms that define how each latent feature contributes to one or more of the tags.

20. The system of claim 19, wherein the output further comprises a probability percentage indicative of each of the explanations contribute to a predicted result based on the learning parameters.
